(19) United States
(12) Patent Application Publication
(10) Pub. No.: US 2009/0085545 A1
(43) Pub. Date: Apr. 2, 2009

(54) VOLTAGE REGULATOR

(75) Inventors: David H. Shen, San Jose, CA (US); Ann P. Shen, Saratoga, CA (US)

Correspondence Address: FISH & RICHARDSON P.C., P.O. BOX 1022, MINNEAPOLIS, MN, 55440-1022, US

(73) Assignee: NANOAMP SOLUTIONS, INC. (Cayman), Santa Clara, CA (US)

(21) Appl. No.: 12/175,316

(22) Filed: Jul. 17, 2008

Related U.S. Application Data
(60) Provisional application No. 60/975,688, filed on Sep. 27, 2007.

(51) Int. Cl. G05F 1/565

(52) U.S. Cl. 323/283

(57) ABSTRACT

In some implementations, a system includes a low-power voltage regulator that can switch between three power modes: a power shutdown mode, a low power mode, and a higher power mode. The system includes a selector coupled to the voltage regulator to switch between the low power mode and the higher power mode, and a switch to switch between the power shutdown mode and the low or higher power mode. The system also has a control circuit to control the switch and the selector to control operation of the voltage regulator in any of the three power modes. A total current used in the voltage regulator in the low power mode is on the order of microamps or nanoamps. The voltage regulator in the low power mode has two to more orders of magnitude of lower current use than the voltage regulator in the higher power mode.

### CROSS-REFERENCE TO RELATED APPLICATIONS

This application claims the benefit of priority to U.S. Provisional Application No. 60/975,688, filed on Sep. 27, 2007, the disclosure of which is incorporated by reference.

### TECHNICAL FIELD

This disclosure relates to voltage regulators, such as voltage regulators in integrated circuits.

### BACKGROUND

Voltage regulators are circuits that can be used to provide a supply voltage to other electronic circuits. Voltage regulators can be designed to maintain a relatively constant output voltage for electronic applications, in which the electronic applications may require a relatively constant supply voltage within a certain tolerance range. In some configurations, the voltage regulator also supplies a current to an output load. In some designs, the circuitry within the voltage regulator may maintain the relatively constant output voltage despite changes in the load current or the input voltage of the regulator.

### SUMMARY

Aspects of the disclosed techniques and designs involve a low power voltage regulator. In some aspects, implementations feature a voltage regulator that includes a regulated voltage output terminal, and a first reference voltage generator that has a first reference voltage output. The first reference voltage generator is configured to produce a first reference voltage on the first reference voltage output. The voltage regulator includes an amplifier having a first input, a second input, and an output, in which the first input is coupled to the first reference voltage output. The voltage regulator also has a transistor having a first terminal, a second terminal, and a third terminal, in which the first terminal is configured to be coupled to a power supply, the second terminal is coupled to the regulated voltage output terminal, and the third terminal is coupled to the output terminal of the amplifier. The voltage regulator also includes a feedback circuit having a first terminal coupled to the regulated voltage output terminal and a second terminal coupled to the second input of the amplifier, and a second reference voltage generator having a second reference voltage output coupled to the third terminal of the transistor. The second reference voltage generator is configured to produce a second reference voltage on the second reference voltage output. The voltage regulator includes a control input coupled to the second reference voltage generator and the amplifier such that the second reference voltage generator is enabled and the amplifier is disabled when a first control input value is applied to the control input, and the second reference voltage generator is disabled and the amplifier is enabled when a second control input value is applied to the control input.

These and other implementations can optionally include one or more of the following features. The second reference voltage generator can be configured such that less power is consumed by the voltage regulator when the first control input value is applied to the control input than when the second control input value is applied to the control input. The control input can be coupled to the first reference voltage generator such that the first reference voltage generator is disabled when the first control input value is applied to the control input and the first reference voltage generator is enabled when a second control input value is applied to the control input. The feedback circuit can include a resistor divider, and the control input can be coupled to the resistor divider in the feedback circuit such that leakage through the resistor divider circuit is prevented when the first control input value is applied to the control input. The control input can be coupled to the feedback circuit through a transistor that is configured to connect the feedback circuit to a ground supply voltage when the second control value is applied to the control input and disconnect the feedback circuit from the ground supply voltage when the first control input value is applied to the control input. The feedback circuit can include a voltage divider circuit that can include any combination of a resistor network, an impedance network, a transistor voltage divider, or an impedance voltage divider.

These and other implementations of the voltage regulator can optionally include one or more of the following features. The second reference generator circuit can include a first device having a first terminal coupled to the power supply, a second terminal coupled to the control input, and a third terminal coupled to one or more elements. The second reference generator circuit can include a second device having a first terminal coupled to the one or more elements, a second terminal coupled to the control input, and a third terminal coupled to a ground voltage supply. The one or more elements in the voltage regulator can include any combination of a resistor, a resistor network, an impedance network, one or more other transistors, one or more diodes, Zener diodes, buried Zener diodes, or emulated Zener diodes. The first device can include a PMOS transistor, a resistor, an impedance, a resistor network, or an impedance network. The first reference voltage generator can include any combination of a bandgap reference voltage generator, a Zener reference voltage generator, a buried Zener reference voltage generator, or an emulated Zener reference voltage generator. The voltage regulator can also have a switch to disable power to the first reference generator circuit or the second reference generator circuit, and a control circuit to control the control input and the enabling or disabling of one or more components of the voltage regulator. The control circuit can include digital circuit or a microprocessor. The control circuit can be configured to control the switch to enable a power shutdown mode for the voltage regulator to reduce an amount of the power dissipation in the voltage regulator from an operating power mode. The switch can include a single transistor or a transmission gate. The switch can be located at any of the following locations in the voltage regulator: between any of the first and second reference voltage generator circuits; between the power supply and any of the first and second reference voltage generator circuits; between the regulated voltage output terminal and any of the first and second reference voltage generator circuits; between the power supply and the regulated voltage output terminal; or between a ground voltage supply and any of the first and second reference voltage generator circuits. The voltage regulator can be configured to operate with a total current on the order of microamps or nanoamps in the low power mode. In some implementations, the voltage regulator can be configured to operate with a total current on the order of microamps or nanoamps in the higher power mode.

In some aspects, some techniques include features for a method for operating a voltage regulator. The voltage regulator includes a regulated voltage output terminal, and a first reference voltage generator having a first reference voltage output. The first reference voltage generator is configured to produce a first reference voltage on the first reference voltage output. The voltage generator includes an amplifier having a first input, a second input, and an output, in which the first input is coupled to the first reference voltage output. The voltage generator also includes a transistor having a first terminal, a second terminal, and a third terminal, in which the first terminal is configured to be coupled to a power supply, the second terminal is coupled to the regulated voltage output terminal, and the third terminal is coupled to the output terminal of the amplifier. The voltage regulator also has a feedback circuit having a first terminal coupled to the regulated voltage output terminal and a second terminal coupled to the second input of the amplifier. The voltage regulator includes a second reference voltage generator having a second reference voltage output coupled to the third terminal of the transistor, in which the second reference voltage generator is configured to produce a second reference voltage on the second reference voltage output. The method includes enabling the second reference voltage generator, disabling the amplifier when the second reference voltage generator is enabled, enabling the amplifier, and disabling the second reference voltage generator when the amplifier is enabled.

These and other implementations can optionally include one or more of the following features. The method can include controlling a control input to switch between a low power dissipation mode and a higher power dissipation mode of the voltage regulator, and controlling a switch to switch between one of the power dissipation modes and a power shutdown mode of the voltage regulator. The step of controlling the control input can control power supplied to a first reference voltage generator circuit of the voltage regulator, a second reference voltage generator circuit, and an amplifier. The reference generator circuits can be coupled to one or more components in the voltage regulator to generate an output voltage on the regulated voltage output terminal of the voltage regulator. The switch can be located at any of the following locations in the voltage regulator: between any of the first and second reference voltage generator circuits; between the power supply and any of the first and second voltage reference generator circuits; between the regulated voltage output terminal and any of the first and second reference voltage generator circuits; between the power supply and the regulated voltage output terminal; or between a ground voltage supply and any of the first and second reference voltage generator circuits.

In some aspects, some implementations include features for a system that includes a voltage regulator having at least three power modes: a power shutdown mode; a low power mode; and a higher power mode. The voltage regulator includes a selector coupled to the voltage regulator to switch between the low power mode and the higher power mode, and a switch to switch between the power shutdown mode and the low power mode or the higher power mode. There is a control circuit for controlling the switch and the selector to control operation of the voltage regulator in any of the three power modes.

These and other implementations can optionally include one or more of the following features. The power shutdown mode can reduce an amount of the power dissipation in the voltage regulator by switching from the low or higher power mode to the power shutdown mode. In some implementations, the power shutdown mode can reduce an amount of power dissipation in the voltage regulator such that the voltage regulator uses a few nanoamps of current or less. The power shutdown mode can reduce the amount of the power dissipation in the voltage regulator by disabling a number of components in the voltage regulator. A total current in the voltage regulator in the low power mode may be on the order of a few microamps or nanoamps. In some implementations, a total minimal current in the voltage regulator in the higher power mode may be on the order of a hundred microamps for a 3V power supply in present CMOS technologies. The higher power mode can enable operation of an amplifier, and the low power mode and the power shutdown mode can disable operation of the amplifier. In some implementations, the low power mode for the voltage regulator can have two or more orders of magnitude of lower current use than the higher power mode. In other implementations, the power shutdown mode for the voltage regulator can have one or several orders of magnitude of lower current use than the low power mode.

In some aspects, some implementations include features for a system that include a regulated voltage output terminal, and a first reference voltage generator having a first reference voltage output, in which the first reference voltage generator is configured to produce a first reference voltage on the first reference voltage output. The system includes an amplifier having a first input, a second input, and an output, in which the first input is coupled to the first reference voltage output. The system has a transistor having a first terminal, a second terminal, and a third terminal, in which the first terminal is configured to be coupled to a power supply, the second terminal is coupled to the regulated voltage output terminal, and the third terminal is coupled to the output terminal of the amplifier. The system has a feedback circuit having a first terminal coupled to the regulated voltage output terminal and a second terminal coupled to the second input of the amplifier. There is a second reference voltage generator having a second reference voltage output coupled to the third terminal of the transistor, in which the second reference voltage generator is configured to produce a second reference voltage on the second reference voltage output. The system includes a control input coupled to the second reference voltage generator and the amplifier such that the second reference voltage generator is enabled and the amplifier is disabled when a first control input value is applied to the control input in the low power dissipation mode, and the second reference voltage generator is disabled and the amplifier is enabled when a second control input value is applied to the control input in the higher power dissipation mode. The system includes at least three power modes: a power shutdown mode; the low power mode; and the higher power mode.

These and other implementations can optionally include one or more of the following features. The system can include any combination of one or more components for receivers, transmitters, and transceivers, in which the regulated voltage output terminal can be coupled to any of the one or more components. The control circuit can include a digital circuit or a microprocessor.

Any of the methods, designs, and techniques described herein can also be implemented in a system, an apparatus or device, a machine, a computer program product, in software, in hardware, or in any combination thereof For example, a computer program product can be tangibly encoded on a computer-readable medium, and can include instructions to cause a data processing apparatus (e.g., a digital circuit, a microprocessor, or a control circuit) to perform one or more operations for any of the voltage regulation methods described herein.

### DESCRIPTION OF THE DRAWINGS

FIG. 1 is a schematic of an example voltage regulator.

FIG. 2 is a schematic of an example implementation of the low power voltage regulator.

FIG. 3 is a schematic of an example implementation of a voltage regulator with various power modes.

FIG. 4 is a schematic of an example implementation of a voltage regulator with various power modes.

### DETAILED DESCRIPTION

Regulators, such as voltage regulators, can be used to generate stable and accurate reference and supply voltages for various types of analog and digital integrated circuits, such as amplifiers and digital logic blocks, respectively. In some implementations, a regulator provides a constant DC voltage and has circuitry to hold that voltage when coupled with other circuits, regardless of the changes in the load current or input voltage.

The following describes one or more implementations of a voltage regulator that can be used to regulate the supply voltage of ultra-low power circuits, such as circuits in low-power portable, wireless, and/or battery devices where the amount of battery life can be important. Some implementations may have very low power consumption (e.g., on the order of nanoamps of current). In some implementations, the very low power voltage regulator herein can have power dissipation that may be two or three orders of magnitude of power lower than some voltage regulators that operate with current on the order of a hundred microamps of current with a supply voltage of around 3V.

In one implementation, a regulator has a low-power mode, a higher-power mode, and a power shutdown mode, and the regulator can transition seamlessly between these modes. In the low-power mode, a reference voltage is generated with a small amount of current (e.g., nanoamps of current) and then used as the reference voltage to drive a regulated supply voltage. In the higher-power mode, the output can be more accurately adjusted than in the low-power mode by using an active element to generate a reference voltage. The power shutdown mode can provide for additional power savings by turning off the voltage regulator when it is not needed. The low power mode for the voltage regulator can generally have two or more orders of magnitude of lower current use than the higher power mode. In some implementations, the power shutdown mode for the voltage regulator can have one or several orders of magnitude of lower current use than the low power mode.

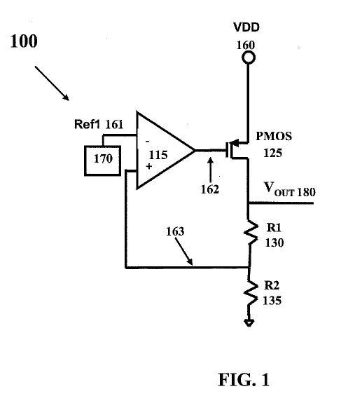

FIG. 1 shows a schematic of an example of a voltage regulator 100. The regulator 100 includes a reference generator 170, which generates a reference voltage 161 with a value of Ref1. The reference voltage 161 is coupled to an inverting input of an amplifier 115, which produces an output 162 that is coupled to the gate of a PMOS transistor 125. The source of the PMOS transistor 125 is coupled to an unregulated power supply 160, which has a value of VDD. The drain of the PMOS transistor 125 is coupled to one end of a first resistor 130, which has a value of R1. The other end of the first resistor 130 is coupled to one end of a second resistor 135, which has a value of R2. The other end of the second resistor 135 is coupled to ground. A feedback voltage 163 is coupled from the node between the first resistor 130 and the second resistor 135 and coupled to the non-inverting input of the amplifier 115. A regulated output voltage 180 is produced at the node between the drain of the PMOS transistor 125 and the first resistor 130 and has a value of Vₒᵤₜ.

In operation, the amplifier 115 uses the reference voltage 161 along with feedback resistors R1 130 and R2 135 to create the regulated output voltage 180. PMOS transistor 125 supplies the current to the regulated output voltage 180. Resistors 130 and 135 are configured in a voltage divider circuit to provide the feedback voltage 163 to the amplifier 115 to help generate the regulated output voltage 180. The regulated output voltage 180 has a value Vₒᵤₜ that is approximately equal to (1+R1/R2)*Ref1. During operation, the regulator circuit 100 can require static power for the reference generator 170 and the amplifier 115, and can require current for the voltage divider formed by R1 130 and R2 135.

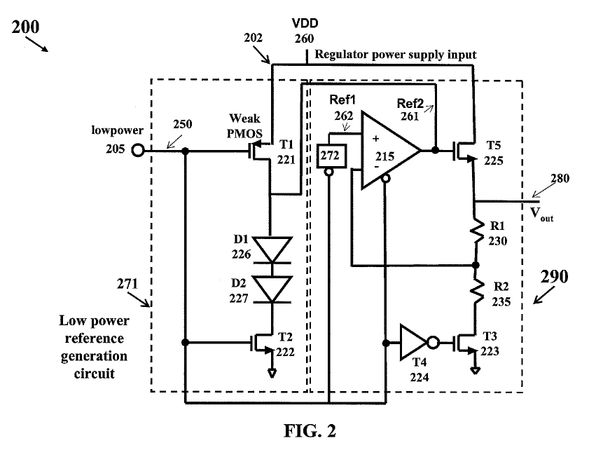

FIG. 2 shows a schematic of an example of a voltage regulator 200 that can be seamlessly switched between at least two power states to generate low power regulated voltages. The voltage regulator 200 includes a power supply input 202, a low-power control input 205, a low-power reference voltage generator 271, a circuit 290, and a regulated voltage output terminal 280.

The circuit 290 includes a reference voltage generator 272 that has a first reference voltage output 262. The reference voltage generator 272 is configured to produce a first reference voltage with a value of Ref1 on the first reference voltage output 262. The output 262 of the first reference voltage generator is coupled to an input of an amplifier 215. The amplifier also has an enable input coupled to the low-power control input 205. The output of the amplifier 215 is coupled to the gate of an NMOS transistor 225. A drain of the transistor 225 is coupled to the power supply input 202 and the source of the transistor 225 is coupled to the regulated voltage output terminal.

Resistors 230 and 235, with values R1 and R2 respectively, form a feedback network having a first terminal coupled to the regulated voltage output terminal 280 and a second terminal coupled to the second input of the amplifier 215. In particular, resistor 230 has one end coupled to the regulated voltage output 280 and a second end coupled to a second input of the amplifier 215 and the drain of a transistor 223. The source of the transistor 223 is coupled to ground. The gate of the transistor 223 is coupled to the output of an inverter 224. The input of the inverter is coupled to the low-power control input 205.

The low-power reference voltage generator 271 includes a PMOS transistor 221. The gate of the transistor 221 is coupled to the low-power control input 205, the source is coupled to the power supply input 202, and the drain is coupled to one end of a series of diodes 226 and 227. The other end of the series of diodes 226 and 227 is coupled to the drain of an NMOS transistor. The gate of the NMOS transistor 222 is coupled to the low-power control input, and the source is coupled to ground. The drain of the transistor 221 is also coupled to the gate of the transistor 225 and forms a second reference voltage output Ref2 261.

In general, depending on the value of a control signal applied to the low-power control input 205, the voltage regulator 200 operates in a low-power mode or a higher-power mode. In the higher-power mode, the amplifier 215 is enabled and is used to adjust a regulated output voltage Vₒᵤₜ at the regulated voltage output terminal 280. However, because the amplifier 215 can be the main static power dissipation component, the amplifier 215 is disabled for the low-power mode, with the output voltage Vₒᵤₜ being generated from the second reference voltage output 261 of the low-power reference voltage generator 271.

Specifically, in the low power mode, the value on the low-power control input is high, and the low-power reference voltage generator 271 is enabled to generate a reference voltage with a value Ref2 on the second reference voltage output 261. The transistors 221 and 222, and diodes 226 and 227 are turned on, and the value Ref2 on the second reference voltage output 261 is equal to a sum of the drain-to-source voltages of transistor 222 and the voltages of the two diodes 226 and 227.

The transistor 221 can be a weak PMOS transistor that functions like a large resistor (e.g., on the order of mega ohms to giga ohms) for the purpose of limiting the current in the low-power reference voltage generator 271, and therefore the power consumed by low-power reference voltage generator 271. Alternatively, any device or component functioning as a large resistor can be used instead of transistor 221.

In the low power mode, the high value on the low-power control input 205 causes the amplifier 215 to be turned off. The low-power control input 205 also passes through inverter 224, which switches the high value to a low value, causing the transistor 223 to switch off. The transistor 224 switching off disconnects the resistors 230 and 235 from ground, which can turn off leakage currents through resistors 230 and 235 during the low power mode. When the power in the amplifier 215 and the currents through the resistors 230 and 235 are all turned off, the static power dissipation can be reduced.

In the low-power mode, the output voltage at the output terminal 280 can have a value Vₒᵤₜ that is a function of the second reference voltage Ref2 261 minus a gate-source voltage Vgs of the transistor 225. Therefore, the smaller the gate-source voltage of Vgs of the transistor 225, the lower the deviation of Vₒᵤₜ from the second reference voltage Ref2 261. If the transistor 225 is a native NMOS transistor with a very small gate-source voltage Vgs, the output regulated voltage Vₒᵤₜ can be kept approximately equal to the second reference voltage Ref2 261.

Some implementations can have different circuits to generate the second reference voltage Ref2. For example, the circuit for the low-power reference voltage generator 271 can have various numbers of diodes to obtain the reference voltage Ref2. In some implementations, different types of diodes or circuits that emulate diodes can be used. Zener diodes or buried Zener diodes operated in reverse direction can also be used for better accuracy. Other implementations can use resistive or impedance networks instead of the array of diodes. Further, some implementations can use a high impedance resistor or a resistive network instead of the transistor 221 to limit the current for the low-power mode.

For additional power savings in the low-power mode, the low-power control input can also be coupled to an enable input of reference voltage generator 272 such that the reference voltage generator 272 is shut down during the low-power mode. In some implementations, the reference generator circuit 272 can be a bandgap reference voltage generator for accurate voltage generation. Some implementations can use Zener diodes or buried Zener circuits that emulate Zener diodes. Other implementations can use resistive networks or impedance networks to generate reference voltages.

When the value of signal on the low-power control input 205 is set low, the regulator 200 operates in the higher-power mode. The circuit 290 is used to generate the voltage on the regulated voltage output terminal 280. In high-power mode, circuit 290 operates in a similar fashion as voltage regulator 100. Vₒᵤₜ in this mode can be equal to (G/(1+G))*Ref1, in which G represents the gain of the amplifier 215. The higher the gain G, the less deviation of Vₒᵤₜ from the reference voltage Ref1. For example, when G=100, the deviation is approximately 1%. The tolerance of the regulator output voltage Vₒᵤₜ can be accurately controlled in the higher-power mode. The output voltage Vₒᵤₜ in the higher-power mode also can be approximately equal to Ref1*(1+R1/R2). Also, the output voltage Vₒᵤₜ can be adjusted by the values of the resistor divider R1 and R2.

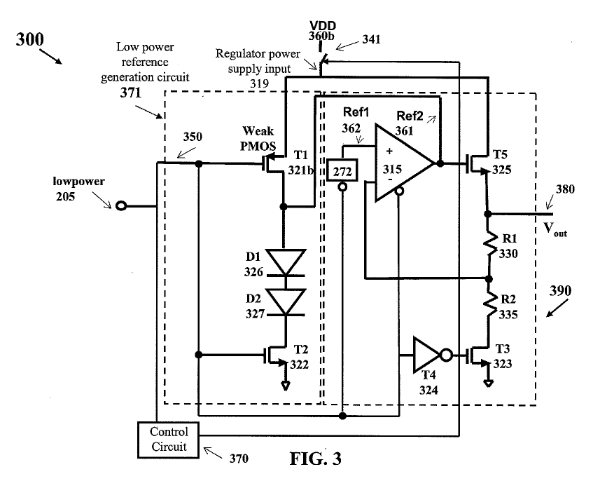

FIG. 3 shows another example embodiment of the low-power voltage regulator 300. FIG. 3 is similar to FIG. 2, except there is a switch 341 for the power shutdown mode, and there is a control circuit 370 for controlling various operating modes of circuit 300. The switch 341 is positioned between a regulator power supply voltage Vdd 360 and a regulator power supply input 319 of the circuit 300. When the switch 341 is switched to a first state of a closed position, the regulator power supply voltage Vdd 360 is coupled to the circuit 300 for the operation modes of low-power and higher-power modes as described with respect to FIG. 2. When the switch 341 is switched to a second state of an open position (e.g., disconnected), the regulator circuit 300 can be in the shutdown mode for powering down the circuit and setting the output voltage Vₒᵤₜ at the output terminal 380 to a ground voltage or zero volts. Alternative implementations can place the switch 341 at the regulator power supply input to the circuit 390 to shut down the output voltage Vₒᵤₜ at the output terminal 380. The operation of the switch 341 and the value on the lowpower terminal 205 can be controlled by the control circuit 370.

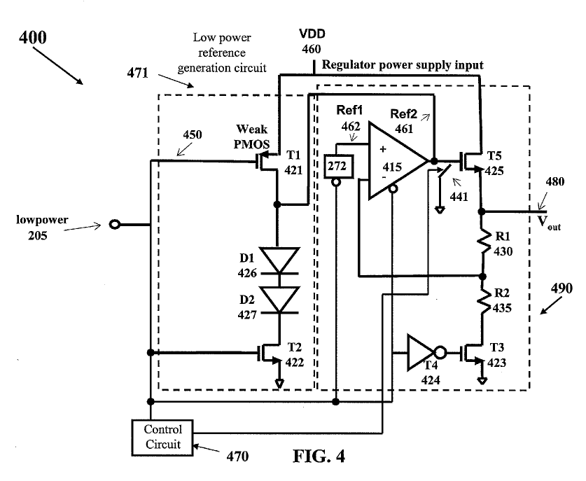

FIG. 4 is another example embodiment of the low-power voltage regulator 400. The low-power regulator in FIG. 4 also has three modes: a low power mode; a higher power mode; and a power shutdown mode. The circuit 400 is similar to the circuit 300 shown in FIG. 3, except for a switch 441 that is positioned between an output of an amplifier 415 and an input to the gate of a transistor 425 for the shutdown mode of the regulator circuit 400. The operation of the switch 441 can be controlled by a control circuit 470. The switch 441 can be used to switch the gate input of the transistor 425 to a first state for the low power and higher power modes. When the switch 441 is open (e.g., disconnected), the switch is in the first state of the open position. When the switch 441 is in the open position, the circuit 400 can function in the low power and higher power modes similar to the circuit 200 in FIG. 2. When the switch 441 is switched in a second state to a closed position (e.g., connected), the gate input of the transistor 425 is coupled to ground, the transistor 425 is turned off, and the output voltage Vₒᵤₜ can drop to a ground voltage (e.g., zero volts). For the power shutdown mode, the transistor 425 can be turned off, and the value on the lowpower terminal 205 can be set high to shut off power in the amplifier 415 and the transistor 423.

Some implementations may have one or more switches to enable or disable power supplied to one or more parts of the voltage regulator. For example, the power associated with the reference voltage generators 471, 272, the amplifier 415, and transistors 421, 425 can be shut off with one or more switches. In some implementations, the control circuit 470 may not have static power dissipation, and may be, for example, a digital circuit or a microprocessor. In another example, a single switch may be able to allow the voltage regulator to operate in and switch between any one of the three modes. These switches may be, for example, two-way switches or three-way switches. The switches may be a single device, a transmission gate, or designed with multiple devices.

In some implementations, the transitions between the different modes can be switched smoothly. In other implementations, the transition to the power shut-down mode may be switched abruptly. Some implementations can have a seamless transition between modes, with little to no undershot or overshot of transients at transitions between the modes.

For example, the disclosed low power regulator techniques can be used with receivers, transmitters, and transceivers, such as the receiver, transmitter, and/or transceiver architectures for superheterodyne receivers, image-rejection (e.g., Hartley, Weaver) receivers, zero-intermediate frequency (IF) receivers, low-IF receivers, direct-up transceivers, two-step up transceivers, and other types of receivers and transceivers for wireless and wireline technologies. The disclosed techniques can be used with any system that has linear voltage regulation such as ASICs, low power microprocessors, microcontrollers, graphics chips, video chips, and digital and/or analog circuits used in communications systems.

Various topologies for circuit models can also be used, other than what are shown in the figures. The exemplary designs shown are not limited to CMOS process technology, but may also use other process technologies, such as BiCMOS (Bipolar-CMOS) process technology, or Silicon Germanium (SiGe) technology. The implementations shown herein are scalable for various process technologies, including process technologies with minimum transistor gate lengths at or below 0.25 μm. The circuits can be single-ended or fully-differential circuits. The techniques set forth in the present disclosure can, for example, provide for relaxed system power requirements, which may be stringent in wireless and/or portable battery operated electronic devices. These low-power techniques can be used to extend the battery life in these electronic devices. The system or design can include other components, where the circuit can couple with those components. Some of the components may include computers, processors, clocks, radios, signal generators, counters, test and measurement equipment, function generators, oscilloscopes, phase-locked loops, frequency synthesizers, phones, wireless communication devices, and components for the production and transmission of audio, video, and other data.

What is claimed is:

1. A voltage regulator comprising:
a regulated voltage output terminal;
a first reference voltage generator having a first reference voltage output, wherein the first reference voltage generator is configured to produce a first reference voltage on the first reference voltage output;
an amplifier having a first input, a second input, and an output, wherein the first input is coupled to the first reference voltage output;
a transistor having a first terminal, a second terminal, and a third terminal, wherein the first terminal is configured to be coupled to a power supply, the second terminal is coupled to the regulated voltage output terminal, and the third terminal is coupled to the output terminal of the amplifier;
a feedback circuit having a first terminal coupled to the regulated voltage output terminal and a second terminal coupled to the second input of the amplifier;
a second reference voltage generator having a second reference voltage output coupled to the third terminal of the transistor, wherein the second reference voltage generator is configured to produce a second reference voltage on the second reference voltage output; and
a control input coupled to the second reference voltage generator and the amplifier such that the second reference voltage generator is enabled and the amplifier is disabled when a first control input value is applied to the control input and the second reference voltage generator is disabled and the amplifier is enabled when a second control input value is applied to the control input.

2. The voltage regulator of claim 1, wherein the second reference voltage generator is configured such that less power is consumed by the voltage regulator when the first control input value is applied to the control input than when the second control input value is applied to the control input.

3. The voltage regulator of claim 1, wherein the control input is coupled to the first reference voltage generator such that the first reference voltage generator is disabled when the first control input value is applied to the control input and the first reference voltage generator is enabled when a second control input value is applied to the control input.

4. The voltage regulator of claim 1, wherein the feedback circuit comprises a resistor divider, and wherein the control input is coupled to the resistor divider in the feedback circuit such that leakage through the resistor divider circuit is prevented when the first control input value is applied to the control input.

5. The voltage regulator of claim 4, wherein the control input is coupled to the feedback circuit through a transistor that is configured to connect the feedback circuit to a ground supply voltage when the second control value is applied to the control input and disconnect the feedback circuit from the ground supply voltage when the first control input value is applied to the control input.

6. The voltage regulator of claim 1, wherein the feedback circuit comprises a voltage divider circuit.

7. The voltage regulator of claim 6, wherein the voltage divider circuit comprises any of a resistor network, an impedance network, a transistor voltage divider, or an impedance voltage divider.

8. The voltage regulator of claim 1, wherein the second reference generator circuit comprises:
a first device comprising a first terminal coupled to the power supply, a second terminal coupled to the control input, and a third terminal coupled to one or more elements; and
a second device comprising a first terminal coupled to the one or more elements, a second terminal coupled to the control input, and a third terminal coupled to a ground voltage supply.

9. The voltage regulator of claim 8, wherein the one or more elements comprise any of a resistor, a resistor network, an impedance network, one or more other transistors, one or more diodes, Zener diodes, buried Zener diodes, or emulated Zener diodes.

10. The voltage regulator of claim 9, wherein the first device comprises a PMOS transistor, a resistor, an impedance, a resistor network, or an impedance network.

11. The voltage regulator of claim 1, wherein the first reference voltage generator comprises any of a bandgap reference voltage generator, a Zener reference voltage generator, a buried Zener reference voltage generator, or an emulated Zener reference voltage generator.

12. The voltage regulator of claim 1, further comprising:
a switch to disable power to the first reference generator circuit or the second reference generator circuit; and
a control circuit to control the control input and the enabling or disabling of one or more components of the voltage regulator.

13. The voltage regulator of claim 12, wherein the control circuit comprises digital circuit or a microprocessor.

14. The voltage regulator of claim 13, wherein the control circuit is configured to control the switch to enable a power shutdown mode for the voltage regulator to reduce an amount of the power dissipation in the voltage regulator by switching from an operating power mode to the power shutdown mode.

15. The voltage regulator of claim 14, wherein the switch comprises a single transistor or a transmission gate.

16. The voltage regulator of claim 14, wherein the switch is located at any of the following locations in the voltage regulator: between any of the first and second reference voltage generator circuits; between the power supply and any of the first and second reference voltage generator circuits; between the regulated voltage output terminal and any of the first and second reference voltage generator circuits; between the power supply and the regulated voltage output terminal; or between a ground voltage supply and any of the first and second reference voltage generator circuits.

17. The voltage regulator of claim 14, wherein the voltage regulator is configured to operate with a total current on the order of microamps or nanoamps in the low power mode.

18. A method comprising:
providing a voltage regulator, the voltage regulator comprising:
a regulated voltage output terminal;
a first reference voltage generator having a first reference voltage output, wherein the first reference voltage generator is configured to produce a first reference voltage on the first reference voltage output;
an amplifier having a first input, a second input, and an output, wherein the first input is coupled to the first reference voltage output;
a transistor having a first terminal, a second terminal, and a third terminal, wherein the first terminal is configured to be coupled to a power supply, the second terminal is coupled to the regulated voltage output terminal, and the third terminal is coupled to the output terminal of the amplifier;
a feedback circuit having a first terminal coupled to the regulated voltage output terminal and a second terminal coupled to the second input of the amplifier; and
a second reference voltage generator having a second reference voltage output coupled to the third terminal of the transistor, wherein the second reference voltage generator is configured to produce a second reference voltage on the second reference voltage output;
enabling the second reference voltage generator;
disabling the amplifier when the second reference voltage generator is enabled;
enabling the amplifier; and
disabling the second reference voltage generator when the amplifier is enabled.

19. The method of claim 18, further comprising:
controlling a control input to switch between a low power dissipation mode and a higher power dissipation mode of the voltage regulator; and
controlling a switch to switch between one of the power dissipation modes and a power shutdown mode of the voltage regulator.

20. The method of claim 19, wherein the controlling the control input controls power supplied to a first reference voltage generator circuit of the voltage regulator, a second reference voltage generator circuit, and an amplifier, wherein the reference generator circuits are coupled to one or more components in the voltage regulator to generate an output voltage on the regulated voltage output terminal of the voltage regulator.

21. The method of claim 20, wherein the switch is located at any of the following locations in the voltage regulator: between any of the first and second reference voltage generator circuits; between the power supply and any of the first and second voltage reference generator circuits; between the regulated voltage output terminal and any of the first and second reference voltage generator circuits; between the power supply and the regulated voltage output terminal; or between a ground voltage supply and any of the first and second reference voltage generator circuits.

22. A system comprising:
a voltage regulator comprising three power modes, wherein the power modes comprise a power shutdown mode, a low power mode, and a higher power mode;
a selector coupled to the voltage regulator to switch between the low power mode and the higher power mode;
a switch to switch between the power shutdown mode and the low power mode or the higher power mode; and
a control circuit to control the switch and the selector to control operation of the voltage regulator in any of the three power modes.

23. The system of claim 22, wherein the power shutdown mode reduces an amount of power dissipation in the voltage regulator by switching from the low or higher power mode to the power shutdown mode.

24. The system of claim 23, wherein the power shutdown mode reduces the amount of power dissipation in the voltage regulator by disabling a number of components in the voltage regulator.

25. The system of claim 22, wherein a total current in the voltage regulator in the low power mode is on the order of microamps or nanoamps.

26. The system of claim 22, wherein the higher power mode enables operation of an amplifier, and the low power mode and the power shutdown mode disables operation of the amplifier.

27. The system of claim 22, wherein the voltage regulator in the low power mode has two or more orders of magnitude of lower current use than the voltage regulator in the higher power mode.

28. The system of claim 22, wherein the voltage regulator in the power shutdown mode has one or more orders of magnitude of lower current use than the voltage regulator in the low power mode.

29. A system comprising:
a regulated voltage output terminal;
a first reference voltage generator having a first reference voltage output, wherein the first reference voltage generator is configured to produce a first reference voltage on the first reference voltage output;
an amplifier having a first input, a second input, and an output, wherein the first input is coupled to the first reference voltage output;
a transistor having a first terminal, a second terminal, and a third terminal, wherein the first terminal is configured to be coupled to a power supply, the second terminal is coupled to the regulated voltage output terminal, and the third terminal is coupled to the output terminal of the amplifier;
a feedback circuit having a first terminal coupled to the regulated voltage output terminal and a second terminal coupled to the second input of the amplifier;
a second reference voltage generator having a second reference voltage output coupled to the third terminal of the transistor, wherein the second reference voltage generator is configured to produce a second reference voltage on the second reference voltage output;
a control input coupled to the second reference voltage generator and the amplifier such that the second reference voltage generator is enabled and the amplifier is disabled when a first control input value is applied to the control input in the low power dissipation mode, and the second reference voltage generator is disabled and the amplifier is enabled when a second control input value is applied to the control input in the higher power dissipation mode, and
wherein the system comprises three power modes, wherein the power modes comprise a power shutdown mode, the low power mode, and the higher power mode.

30. The system of claim 29, wherein the control circuit comprises a digital circuit or a microprocessor.

31. The system of claim 29, further including any combination of one or more components for receivers, transmitters, and transceivers, wherein the regulated voltage output terminal is coupled to any of the one or more components.
